(19) United States
(12) Patent Application Publication
(10) Pub. No.: US 2008/0043491 A1
(43) Pub. Date: Feb. 21, 2008

(54) Light emitting unit and light guiding element thereof

(75) Inventor: Feng-Li Lin, Taishan Township (TW)

Correspondence Address: BIRCH STEWART KOLASCH & BIRCH, PO BOX 747, FALLS CHURCH, VA, 22040-0747, US

(73) Assignee: Gigno Technology Co., Ltd.

(21) Appl. No.: 11/889,407

(22) Filed: Aug. 13, 2007

(30) Foreign Application Priority Data
Aug. 16, 2006 (TW) 095130153

(51) Int. Cl. F21V 8/00; F21V 7/04

(52) U.S. Cl. 362/623

(57) ABSTRACT

A light guiding element includes a light emitting portion, a reflecting portion and a light mixing portion. The reflecting portion has a reflecting surface, the reflecting portion is connected to one side of the light emitting portion, and the light mixing portion is connected to the reflecting portion and forms an included angle with the light emitting portion. A light emitting unit is also disclosed.

### CROSS REFERENCE TO RELATED APPLICATIONS

This Non-provisional application claims priority under 35 U.S.C. §119(a) on Patent Application No(s). 095130153 filed in Taiwan, Republic of China on Aug. 16, 2006, the entire contents of which are hereby incorporated by reference.

### BACKGROUND OF THE INVENTION

1. Field of Invention

The invention relates to a light emitting unit and a light guiding element thereof, and, in particular, to a light emitting unit capable of lengthening a light mixing distance, and a light guiding element thereof.

2. Related Art

With the coming of the digital age, the technology for the liquid crystal display (LCD) device also has grown rapidly, and the LCD device has become an indispensable electronic product. Thus, the requests on the technology and the function of the LCD device have become higher and higher.

In general, the LCD device mainly includes a LCD panel and a backlight module. The LCD panel mainly has two substrates and a liquid crystal layer interposed between the substrates. The backlight module outputs uniform light rays to be distributed over the surface of the LCD panel, and may thus be referred to as a light emitting unit.

Referring to FIGS. 1 and 2, a conventional light emitting unit 1 includes a light guiding element 11, a circuit board 12 and a plurality of light emitting elements 13. Each light emitting element 13 is disposed on the circuit board 12 and disposed adjacent to the light guiding element 11. In this example, the light emitting elements 13 are light emitting diodes for outputting different colors of light rays (e.g., red, blue and green light rays). FIG. 2 is a schematically cross-sectional view taken along a line A-A′ of FIG. 1. The light rays outputted by the light emitting elements 13 enter the light guiding element 11. Thereafter, the light rays are mixed by the light guiding element 11 and then reflected, by a micro-structure or a mesh point structure disposed on a bottom surface 111 of the light guiding element 11, to a light emitting surface 112 of the light guiding element 11. Finally, the light rays are emitted from the light emitting surface 112.

At present, the LCD devices have been widely used. More particularly, the miniaturized LCD devices have played important roles among these electronic products. Thus, when the size or the thickness of the LCD device gets smaller, the distance between the light emitting element 13 and the light guiding element 11 of the light emitting unit 1 is shorter. In the above-mentioned structure of the light emitting unit 1, the different colors of light rays outputted from the light emitting elements 13 cannot be sufficiently mixed or may become non-uniform so that the quality of the light emitting unit 1 is deteriorated because the light mixing distance is not long enough.

Therefore, it is an important subject to provide a light emitting unit capable of lengthening the light mixing distance effectively and enhancing the uniformity of the mixed light, and a light guiding element thereof.

### SUMMARY OF THE INVENTION

In view of the foregoing, the invention is to provide a light emitting unit capable of lengthening a light mixing distance effectively and enhancing the uniformity of the mixed light, and a light guiding element thereof.

To achieve the above, the invention discloses a light guiding element, which includes a light emitting portion, a reflecting portion and a light mixing portion. The reflecting portion has a reflecting surface and is connected to one side of the light emitting portion. The light mixing portion is connected to the reflecting portion and forms an included angle with the light emitting portion.

To achieve the above, the invention also discloses a light guiding element, which includes a light emitting portion, a plurality of reflecting portions and a plurality of light mixing portions. Each of the reflecting portions has a reflecting surface, and the reflecting portions are respectively connected to a circumference of the light emitting portion. The light mixing portions are connected to the reflecting portions and form included angles with the light emitting portion, respectively.

To achieve the above, the invention discloses a light emitting unit, which includes a plurality of light emitting elements and a light guiding element. The light guiding element has a light emitting portion, a reflecting portion and a light mixing portion. The reflecting portion has a reflecting surface and is connected to one side of the light emitting portion. The light mixing portion is connected to the reflecting portion and forms an included angle with the light emitting portion. The light mixing portion is disposed on the light emitting elements. The light rays outputted from the light emitting elements enter the light mixing portion.

As mentioned above, a light emitting portion, a reflecting portion and a light mixing portion of the light guiding element are provided to lengthen the light mixing distance in the light emitting unit and the light guiding element thereof according to the invention. The reflecting portion having one reflecting surface is connected to one side of the light emitting portion, and the light mixing portion is connected to the reflecting portion and forms an included angle with the light emitting portion. Also, the light mixing portion is disposed on each of the light emitting elements, and the light rays outputted from the light emitting elements enter the light mixing portion. Compared with the related art, the light mixing portion mixes the light rays outputted from the light emitting elements, and then the reflecting portion reflects the mixed light rays to the light emitting portion in the light emitting unit and the light guiding element thereof. The light rays may be mixed in the light mixing portion as well as the reflecting portion and the light emitting portion, and finally emitted from the light emitting portion. In this manner, the light mixing distance may be effectively lengthened, and the mixed light rays may become more uniform so that the quality of the light emitting unit may be enhanced.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic illustration showing a conventional light emitting unit;

FIG. 2 is a cross-sectional view showing the conventional light emitting unit;

FIG. 3 is a schematic illustration showing a light emitting unit according to a preferred embodiment of the invention;

FIG. 4 is a schematically cross-sectional view showing the light emitting unit according to the preferred embodiment of the invention;

FIG. 5 is a schematic illustration showing another light emitting unit having another light guiding element according to the preferred embodiment of the invention, wherein the light guiding element has one light emitting portion, four reflecting portions and four light mixing portions;

FIG. 6 is a schematically cross-sectional view showing the light emitting unit according to the preferred embodiment of the invention; and

FIG. 7 is a schematic illustration showing the light emitting unit, being a backlight module, according to the preferred embodiment of the invention.

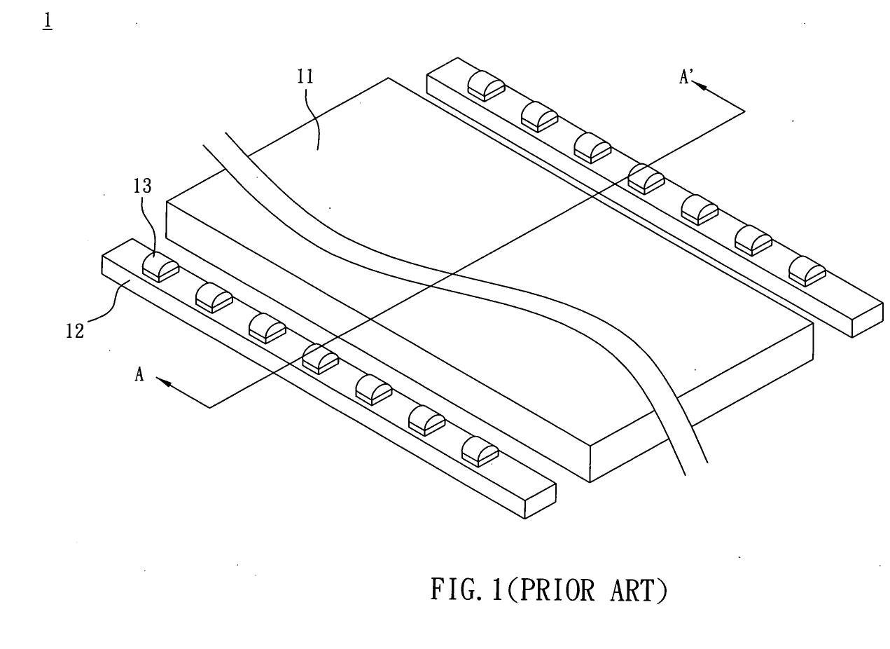

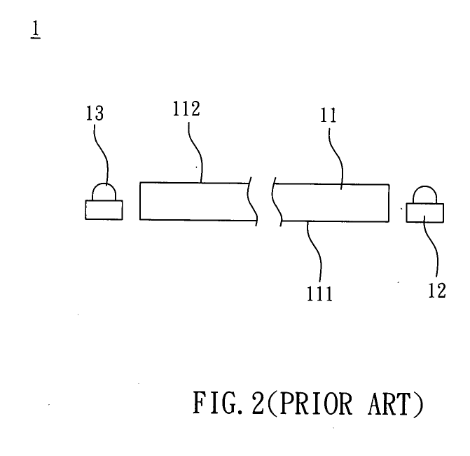

### DETAILED DESCRIPTION OF THE INVENTION

The present invention will be apparent from the following detailed description, which proceeds with reference to the accompanying drawings, wherein the same references relate to the same elements.

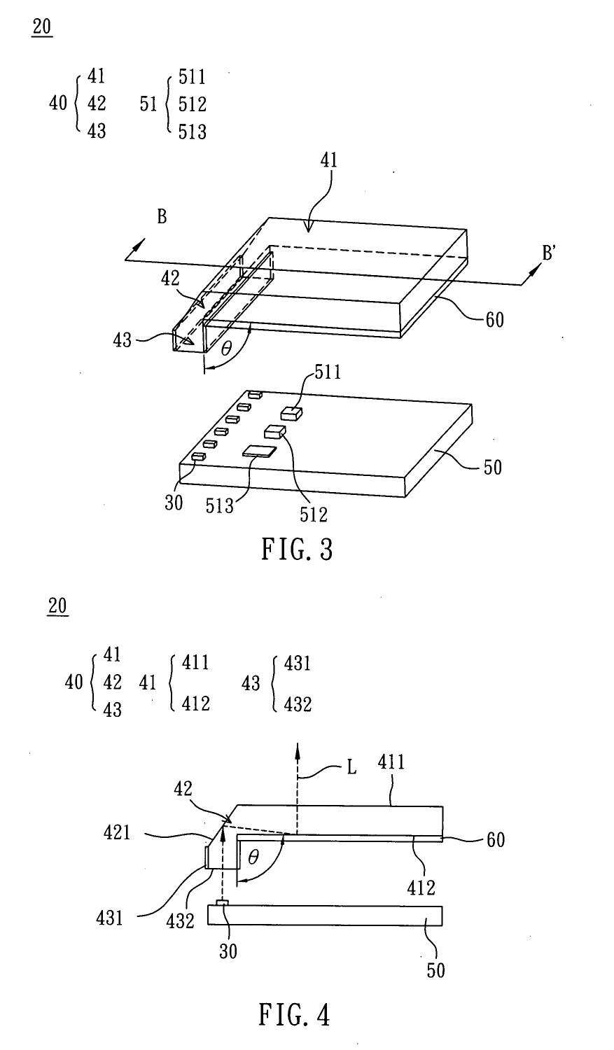

Please refer to FIGS. 3 and 4 simultaneously, wherein FIG. 4 is a schematically cross-sectional view taken along a line B-B of FIG. 3. A light emitting unit 20 according to the preferred embodiment of the invention includes a plurality of light emitting elements 30 and a light guiding element 40. The light emitting unit 20 of this embodiment is not particularly restricted, and may be implemented as an illumination device used in the daily life or a backlight module used in a liquid crystal display (LCD). Herein, the light emitting unit 20 is the backlight module.

In this embodiment, the light emitting element 30 is not particularly restricted and may be implemented as including a light emitting diode (LED), a LED array or a cold cathode fluorescent lamp (CCFL). Herein, the light emitting elements 30 include a plurality of red, blue and green light emitting diodes.

In addition, the light emitting unit 20 of this embodiment further includes a circuit board 50, and each light emitting element 30 is disposed on the circuit board 50 and electrically connected to the circuit board 50. In this example, the light emitting elements 30 are disposed on an edge of the circuit board 50. In addition, the circuit board 50 may further include at least one electronic element 51 electrically connected to the circuit board 50. In this embodiment, the electronic element 51 includes a thermister 511, a photosensor 512 and a control drive circuit 513, for example. The thermister 511 senses an external environment temperature or a temperature of the light emitting element 30. The photosensor 512 senses the external light intensity or the light intensity of the light emitting element 30. The control drive circuit 513 controls and drives the light emitting element 30.

As shown in FIGS. 3 and 4, the light guiding element 40 of this embodiment has a light emitting portion 41, a reflecting portion 42 and a light mixing portion 43. The light guiding element 40 of this embodiment is not particularly restricted and may be implemented as a light guiding plate. Herein, the light guiding element 40 is a light guiding plate of a backlight module and disposed above the circuit board 50 and the light emitting elements 30.

In this embodiment, the light mixing portion 43 is connected to the reflecting portion 42 and forms an included angle θ with the light emitting portion 41. In the implementation, the included angle θ may be greater than (not shown) or equal to 90 degrees (see FIG. 4). The light mixing portion 43 is disposed on each light emitting element 30, so the light emitting elements 30 are arranged according to the arrangement of the light mixing portion 43. In addition, the aspect of the light mixing portion 43 is not particularly restricted, and the light mixing portion 43 may be a plate. In addition, the light mixing portion 43 may further include a micro-structure (not shown) and at least one reflector 431. The micro-structure is disposed on a bottom surface 432 of the light mixing portion 43 to break the total reflection so that the light rays outputted from the light emitting elements 30 may be easily guided into the light mixing portion 43. The reflector 431 is disposed on one side surface of the light mixing portion 43. Of course, the reflectors 431 may also be disposed on four side surfaces of the light mixing portion 43. Herein, the reflectors 431 are disposed on two opposite sides of the light mixing portion 43, as shown in FIGS. 3 and 4, and reflect the light rays outputted from the light mixing portion 43 back to the light mixing portion 43 to enhance the light availability.

The reflecting portion 42 of this embodiment has a reflecting surface 421 and is connected to one side of the light emitting portion 41 so that the reflecting surface 421 is disposed adjacent to a light emitting surface 411 of the light emitting portion 41. The reflecting surface 421 of this embodiment may be implemented as an inclined surface or an arced surface, and is an inclined surface in this example. In this embodiment, the reflecting surface 421 reflects the light rays, which are outputted from the light emitting elements 30 and pass through the light mixing portion 43, to the light emitting portion 41, and the light rays may also be continuously mixed as they are reflected by the reflecting surface 421.

In this embodiment, the light emitting portion 41 is a plate, for example, and the light emitting portion 41 may have a micro-structure and a mesh point pattern (not shown). The mesh point pattern is disposed on a bottom surface 412 of the light emitting portion 41, and reflects the light rays outputted from the light emitting elements 30 back to the light emitting surface 411. The micro-structure is disposed on the light emitting surface 411 of the light emitting portion 41 to break the total reflection so that the light rays may be emitted from the light emitting surface 411. The bottom surface 412 of this embodiment is disposed opposite to the light emitting surface 411. In addition, referring to FIGS. 3 and 4 simultaneously, the light emitting unit 20 of this embodiment further includes a reflecting plate 60 disposed on the bottom surface 412 of the light emitting portion 41.

In addition, the light mixing portion 43, the light emitting portion 41 and the reflecting portion 42 of this embodiment may be manufactured in various manners, which are not particularly restricted. In the implementation, the light mixing portion 43, the light emitting portion 41 and the reflecting portion 42 may be integrally formed or may be formed by way of punching or pressing. The material of the light mixing portion 43, the light emitting portion 41 and the reflecting portion 42 is not particularly restricted. In the implementation, the material thereof may be a transparent light guiding material, such as polycarbonate.

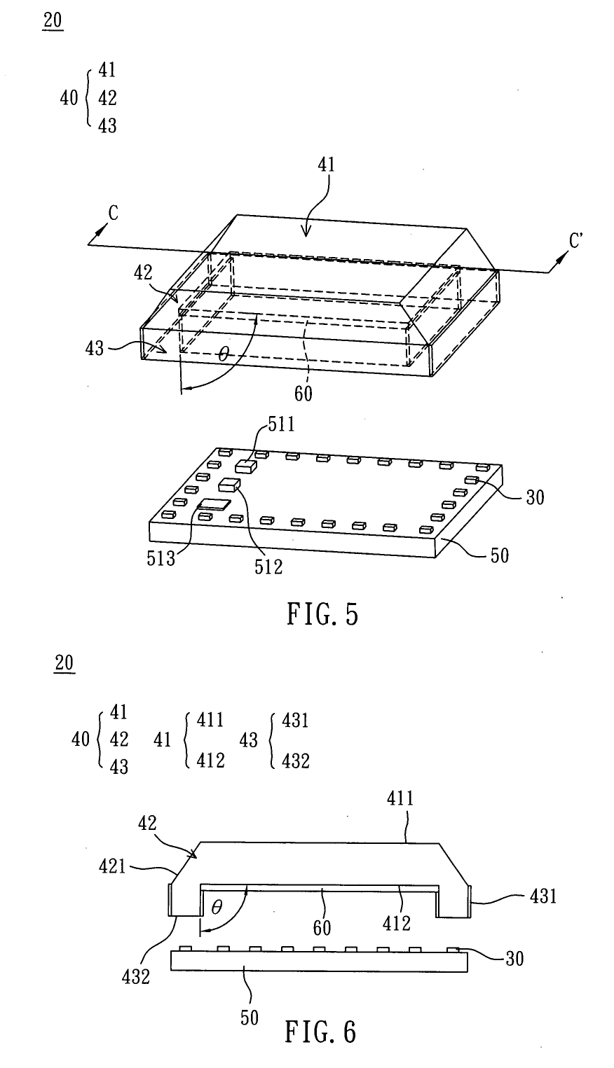

In addition, the structure of the light guiding element 40 of this embodiment may include the combination of one light emitting portion 41, at least one reflecting portion 42 and at least one light mixing portion 43. For example, the structure includes the combination of one light emitting portion 41, one reflecting portion 42 and one light mixing portion 43, as shown in FIG. 3, or the combination of one light emitting portion 41, four reflecting portions 42 and four light mixing portions 43, as shown in FIGS. 5 and 6, wherein FIG. 6 is a schematically cross-sectional view taken along a line C-C′ of FIG. 5. At this time, each reflecting portion 42 is disposed on the circumference of the light emitting portion 41, the reflecting surface 421 of each reflecting portion 42 is also disposed adjacent to the light emitting surface 411 of the light emitting portion 41, and each light mixing portion 43 is connected to the corresponding reflecting portion 42 and forms an included angle θ with the light emitting portion 41. In addition to the above-mentioned structure according to the above-mentioned embodiment, as shown in FIGS. 3 to 5, the light guiding element 40 may include the combination of one light emitting portion 41, two reflecting portions 42 and two light mixing portions 43 (not shown).

Referring to FIG. 4 with reference to the arrow L of the path of the light rays outputted from the light emitting element 30, the light rays, such as red, blue or green rays, emitted from the light emitting elements 30 of the light emitting unit 20 enter the light mixing portion 43, and are mixed in the light mixing portion 43 in advance. Then, the mixed light rays are reflected by the reflecting surface 421 of the reflecting portion 42 to the light emitting portion 41, and the bottom surface 412 of the light emitting portion 41 cooperates with the reflecting plate 60 so that the mixed light rays are reflected by the bottom surface 412 of the light emitting portion 41 and then emitted from the light emitting surface 411 of the light emitting portion 41, and the light rays which are uniformly mixed may be obtained.

The light mixing portion 43 may mix the light rays outputted from the light emitting elements 30 uniformly, and then the reflecting portion 42 reflects the mixed light rays to the light emitting portion 41 in the light emitting unit 20. The light rays may be mixed in the light mixing portion 43 as well as the light emitting portion 41, which is also made of the transparent light guiding material, and may be finally emitted from the light emitting surface 411 of the light emitting portion 41. In this manner, the cooperation of the light mixing portion 43, the reflecting portion 42 and the light emitting portion 41 can lengthen the light mixing distance effectively so that the mixed light rays become more uniform.

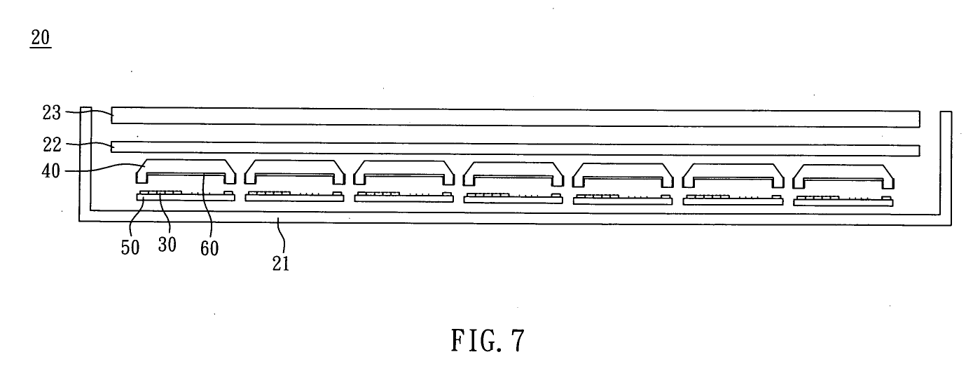

In this embodiment, one light guiding element 40, a plurality of light emitting elements 30 and one circuit board 50 may be provided to form the light emitting unit 20, as shown in FIG. 3. Also, a plurality of light guiding elements 40, a plurality of light emitting elements 30 and a plurality of circuit boards 50 may be provided to form an array, as shown in FIG. 7, so that more light rays may be emitted.

Referring to FIG. 7, the light emitting unit 20 may further include a housing 21, a diffuser plate 22 and an optical film set 23. The plurality of light guiding elements 40 and the plurality of circuit boards 50 for carrying the light emitting elements 30 are disposed on the housing 21, the diffuser plate 22 is disposed above the light guiding elements 40, and the optical film set 23 is disposed on the diffuser plate 22. In addition, the optical film set 23 may have an upper diffuser plate, a brightness enhancement film and a lower diffuser plate (not shown). The upper diffuser plate and the lower diffuser plate are disposed opposite to each other so that the brightness enhancement film is disposed between the upper diffuser plate and the lower diffuser plate. Consequently, the housing 21, the diffuser plate 22, the optical film set 23, the light guiding element 40, the light emitting element 30, the reflecting plate 60 and the circuit board 50 may be assembled to form a backlight module.

In summary, a light emitting portion, a reflecting portion and a light mixing portion of the light guiding element are provided to lengthen the light mixing distance in the light emitting unit and the light guiding element thereof according to the invention. The reflecting portion having one reflecting surface is connected to one side of the light emitting portion, and the light mixing portion is connected to the reflecting portion and forms an included angle with the light emitting portion. Also, the light mixing portion is disposed on each of the light emitting elements, and the light rays outputted from the light emitting elements enter the light mixing portion. Compared with the related art, the light mixing portion mixes the light rays outputted from the light emitting elements, and then the reflecting portion reflects the mixed light rays to the light emitting portion in the light emitting unit and the light guiding element thereof. The light rays may be mixed in the light mixing portion as well as the reflecting portion and the light emitting portion, and finally emitted from the light emitting portion. In this manner, the light mixing distance may be effectively lengthened, and the mixed light rays may become more uniform so that the quality of the light emitting unit may be enhanced.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A light guiding element, comprising:
a light emitting portion;
a reflecting portion, which has a reflecting surface and is connected to one side of the light emitting portion; and
a light mixing portion, which is connected to the reflecting portion and forms an included angle with the light emitting portion.

2. The light guiding element according to claim 1, wherein each of the light mixing portion, the light emitting portion and the reflecting portion is made of a transparent light guiding material.

3. The light guiding element according to claim 1, wherein each of the light emitting portion and the light mixing portion is a plate.

4. The light guiding element according to claim 1, wherein the included angle is greater than or equal to 90 degrees.

5. The light guiding element according to claim 1, wherein the light emitting portion, the reflecting portion and the light mixing portion are integrally formed.

6. The light guiding element according to claim 1, wherein the reflecting surface is an inclined surface or an arced surface and is disposed adjacent to a light emitting surface of the light emitting portion.

7. The light guiding element according to claim 6; wherein the light emitting portion has a micro-structure disposed on the light emitting surface.

8. The light guiding element according to claim 6, further comprising:
a reflecting plate disposed on a bottom surface of the light emitting portion, wherein the bottom surface is disposed opposite to the light emitting surface.

9. The light guiding element according to claim 8, wherein the light emitting portion has a mesh point pattern disposed on the bottom surface.

10. The light guiding element according to claim 1, further comprising at least one reflector disposed on one side of the light mixing portion.

11. A light emitting unit, comprising:
a plurality of light emitting elements; and
a light guiding element having a light emitting portion, a reflecting portion and a light mixing portion, wherein the reflecting portion has a reflecting surface, the reflecting portion is connected to one side of the light emitting portion, the light mixing portion is connected to the reflecting portion and forms an included angle with the light emitting portion, the light mixing portion is disposed on the light emitting elements, and light rays outputted from the light emitting elements enter the light mixing portion.

12. The light emitting unit according to claim 11, wherein the light emitting element is a light emitting diode (LED), a light emitting diode array or a cold cathode fluorescent lamp (CCFL).

13. The light emitting unit according to claim 11, wherein each of the light mixing portion, the light emitting portion and the reflecting portion is made of a transparent light guiding material.

14. The light emitting unit according to claim 11, wherein each of the light emitting portion and the light mixing portion is a plate.

15. The light emitting unit according to claim 11, wherein the included angle is greater than or equal to 90 degrees.

16. The light emitting unit according to claim 11, wherein the light emitting portion, the reflecting portion and the light mixing portion are integrally formed.

17. The light emitting unit according to claim 11, wherein the reflecting surface is an inclined surface or an arced surface and is disposed adjacent to a light emitting surface of the light emitting portion.

18. The light emitting unit according to claim 17, wherein the light emitting portion has a micro-structure disposed on the light emitting surface.

19. The light emitting unit according to claim 17, further comprising:
a reflecting plate disposed on a bottom surface of the light emitting portion, wherein the bottom surface is disposed opposite to the light emitting surface.

20. The light emitting unit according to claim 19, wherein the light emitting portion has a mesh point pattern disposed on the bottom surface.

21. The light emitting unit according to claim 11, wherein when the light rays outputted from the light emitting elements enter the light mixing portion, the light rays are mixed by the light mixing portion, then reflected by the reflecting portion to the light emitting portion, and then emitted from the light emitting portion.

22. The light emitting unit according to claim 11, further comprising a circuit board, wherein the light emitting elements are disposed on the circuit board and electrically connected to the circuit board.
